(19) United States
(12) Patent Application Publication
(10) Pub. No.: US 2021/0149378 A1
(43) Pub. Date: May 20, 2021

(54) Industrial Control System in Automation Technology with Independently Operating Modules

(71) Applicant: Robert Bosch GmbH, Stuttgart (DE)

(72) Inventors: Alexander Breitenbach, Frammersbach (DE); Michael Langfinger, Aschaffenburg (DE)

(21) Appl. No.: 17/097,143

(22) Filed: Nov. 13, 2020

(30) Foreign Application Priority Data
Nov. 15, 2019 (DE) 102019217624.0

(51) Int. Cl. G05B 19/418; H04L 29/08

(52) U.S. Cl. CPC G05B 19/4185; H04L 67/28; G05B 19/4183

(57) ABSTRACT

A control system in industrial automation technology includes hardware having at least one processor and at least one storage device, in which applications to be executed by the control system are stored. The control system is configured such that at least two and preferably a plurality of mutually isolated execution environments are provided and/or configured. At least two, and preferably a plurality, of independently executable and/or operating functional modules are included, each of which can be executed and/or operate, in particular exclusively, in an isolated execution environment. The functional modules are characteristic of functions of the control system.

This application claims priority under 35 U.S.C. § 119 to patent application no. DE 10 2019 217 624.0, filed on Nov. 15, 2019 in Germany, the disclosure of which is incorporated herein by reference in its entirety.

The disclosure relates to an, in particular industrial, control system, in particular in the field of industrial automation technology, and to a method in industrial automation technology for operating a control system or an automation device. Preferably, the disclosure relates to a method and/or an industrial control system or software for industrial control in modules that operate independently of each other.

In addition, the disclosure relates to a computer program, comprising commands that cause the control system to execute the method steps and to a computer-readable storage medium on which the computer program is stored.

The disclosure can be applied in particular to a machine tool, for example a milling, grinding or pressing machine, a packaging machine, a loading portal device, a filling machine, a hydraulic press or an automation system or automation device. In addition, applications are also conceivable in systems with electrical, hydraulic or pneumatic drives.

### BACKGROUND

From a technical point of view, modern industrial systems from the prior art are typically monolithic systems. The operating system core, operating system and applications are bundled together as firmware. Furthermore, in modern industrial systems, IT security mechanisms—where present—are often provided independently by each component (application, operating system, . . . ).

These aspects have a negative effect as soon as individual components need to be updated, for example due to security vulnerabilities. In such a case, the entire firmware must always be replaced. In this case, multiple components are usually updated at once, which significantly increases the risk of possible side effects and resulting downtimes. This is also a reason why impending security updates are often completely avoided and the resulting risk is accepted.

However, particularly with regard to future or existing applied scenarios in the context of Industry 4.0—and hence the increasing networking of the devices—there is an increasing need to close security gaps by means of software updates in a timely manner when vulnerabilities become known. As already stated above, however, updating the software of an automation system is currently associated with high costs and risks due to the architecture.

### SUMMARY

An object of the disclosure is therefore to provide a control system and a method, in particular in industrial automation technology, or a computer code, by means of which the effort or risk associated with updating a piece of software is significantly reduced.

A control system according to the disclosure (in particular automation system), in particular in the field of industrial automation technology, has hardware comprising at least one processor and at least one storage device, in which applications to be executed by the control system, in particular by the processor, can be (or are) stored, wherein the control system is configured in such a way that at least two and preferably a plurality of mutually isolated execution environments are provided and/or configured. The control system is preferably suitable and designed to perform one or more control engineering applications or tasks (in particular software tasks), in particular control of a machine and/or automation equipment control. The control system can be used, for example, for the monitoring and/or open-loop and/or closed-loop control of an (automated) process, such as an automation device and/or field device and/or actuator and/or drive controller.

According to the disclosure, at least two, and preferably a plurality of, functional modules are provided which are executable and/or operate independently of each other, each of which is executable (and preferably is executed) and/or operate, in particular exclusively, in an isolated execution environment. The functional modules (in particular each of them) are characteristic of (different) functions (or functional areas) of the control system. In particular, the functional modules are characteristic of (different) functions (or functional areas) and/or components of a firmware (of the control system). The functional modules (preferably all of them) are (in each case) capable of running independently.

In other words, the disclosure proposes modules that operate independently of each other. The modular provision of the individual applications or operating system core and/or operating system and/or controller core reduces both the effort of updating the control system software and the risk. It is therefore proposed that instead of a monolithic system with a bundled deployment of the operating system core, operating system and applications, a modular system should be provided in which the respective functional modules are executed in isolation from each other and are capable of running independently. As a result, updating the software and the security of a given function affects only a single module, not the entire firmware.

Preferably, each isolated execution environment is allocated a portion of the total system resources. Preferably, the isolated execution environment is implemented, in particular the isolated execution environments are implemented, as a sandbox. The system resources are in particular understood to mean the (preferably real) system resources available in the (entire) control system and/or one or more and preferably all hardware component(s) of the control system. Preferably, each isolated execution environment is and/or will be allocated exclusive system resources, in particular exclusive (physical) hardware and/or operating-system resources (and/or firmware resources). These are preferably real system resources, not virtual system resources.

A functional module is understood in particular to be a (virtual) module which groups or comprises (or even represents), for example, a functional unit of the firmware of the control system. Different functional modules preferably relate to different functions.

In an advantageous embodiment, the function of the control system is selected from a group that comprises the controller core, the operating system core, applications, communication and the like (e.g. other firmware components), as well as combinations of these. These functions are preferably implemented as modules. In other words, a functional module is characteristic of (at least and preferably exactly) one component selected from the group comprising the controller core, the operating system core, various applications, communication and the like, as well as combinations of these. Preferably, one and preferably any task to be performed by the firmware and/or the control system can be (uniquely) assigned to exactly one functional module.

Preferably, each function module is only allowed (direct) access to the system resources assigned to it (in particular without performing access authorization). Preferably, each functional module (in particular without access authorization) is unable to access the system resources assigned to a function module, and particularly preferably any other function module. Preferably, each function module is only allowed access to the files (or the file system of the respective isolated execution environment and, in particular, the respective sandbox) and/or only access to the configuration of the (respective) isolated execution environment, in particular the respective sandbox. Each functional module preferably has no access to the files assigned to a (and preferably any) other functional module and/or to the configuration of the respective isolated execution environment (in particular the respective sandbox of the other functional module). Preferably, each functional module has an independent and/or protected storage management. Storage virtualization is preferably performed (in particular via a virtualization layer of the control system), which provides, and particularly preferably allows access to, (only) a subset of the physically available (main) memory to each of the individual isolated execution environments (and hence to the functional modules).

Preferably, the control system has at least one functional module which is characteristic of an operating system core, and/or at least one functional module which is characteristic of a controller core, and/or at least one functional module which is characteristic of an application, and/or at least one functional module which is characteristic of a real-time application. Different applications are preferably executed as different functional modules.

Preferably, (essentially) all applications are executed as (in each case separate) functional modules. Different components of the firmware are preferably divided into (separate) functional modules. For example, the firmware can be divided into the smallest possible (in each case functionally coherent) components and executed as a separate functional module. This offers the advantage of involving a minimum effort and risk when updating the software of a component.

In an advantageous embodiment, a communication and/or interaction between two functional modules can take place, preferably exclusively, via at least one specified communication channel, in particular an interface, or via a plurality of specified communication channels (in particular interfaces). In other words, communication and/or interaction between the (functional) modules is preferably only possible via defined interfaces. This advantageously allows a non-reactive updating of individual components of the system. Preferably, a communication and/or interaction between two functional modules is possible exclusively via IP-based network communication and/or via an interface-based communication layer.

Preferably, the access by an (any) application or access by an application running within a functional module to the system resources assigned (in particular exclusively) to an isolated execution environment is only possible if this application or program is assigned and/or can be assigned to this functional module, which can be executed and/or operates in the isolated execution environment.

In another advantageous embodiment at least one (preferably exactly one) central module is provided for executing and/or performing at least one function relating to a functional module, wherein the function has preferably been delegated to the central module by a functional module and wherein the central module is preferably executed and/or operates in an isolated execution environment. This function primarily affects the (IT) security of the functional module. Provision of a central module offers the advantage of being able to outsource or delegate functions required or used by multiple functional modules to a (common) central module. This central module function (which is shared or executable for multiple functional modules) does not need to be updated for each individual functional module, but can be updated in a single step.

The central module is preferably configured and designed to perform one (at least one) function for at least one functional module and preferably for a plurality of functional modules.

In another advantageous embodiment, the central module contributes to ensuring the security of at least one functional module and/or of the control system, and/or to making the central module suitable and/or configured to execute at least one function relating to transport encryption, administration of users and/or groups, and/or enforcement of access restrictions. The central module preferably manages at least one security-relevant mechanism, preferably more than one and particularly preferably (essentially) all security-relevant mechanisms. In other words, in the control system the security-relevant mechanisms—e.g. the transport encryption, the management of users and groups, the enforcement of access restrictions—are preferably managed by a central component (central module).

In a further advantageous embodiment, at least one functional module and preferably a plurality of functional modules provides configuration data to the central module, in particular via an adapter, and/or transfers configuration data, wherein the configuration data are preferably characteristic of a security measure. An application executed as a (functional) module therefore preferably needs to provide this central component (or the central module) with only a small number of security-relevant configuration data. Security for accessing the device is then enforced by the central component (the central module). This simplifies the development of applications by third-party developers (who can focus on functional aspects) and reduces potential sources of error due to incorrect implementations of security mechanisms in the applications.

A functional module, and particularly preferably every functional module, has an adapter for configuration data. Via this adapter, the individual functional modules provide the central module (optionally) with a configuration module.

The control system is preferably configured in such a way that the central module provides security functions (security measures) to at least one functional module and preferably to all functional modules and/or the applications executed as functional modules.

In a further advantageous embodiment, the central module functions as a proxy, in particular for communication requests, preferably for access requests to an application, and/or for granting access to an application. Thus, the central module (in its capacity as a security module) is preferably suitable for bundling requests to the device as a proxy and/or to enable access to applications only via a defined access route. This reduces the potential target area for attackers.

Preferably, the control system is configured in such a way that communication and/or data exchange with a functional module, which takes place, for example, via an external interface and/or with an external client and/or with a party outside the control system or automation device, takes place at all times via the central module. The central module preferably manages access authorizations, particularly preferably separately for (each functional module or) the functional modules. The central module preferably has a storage device in which configuration data and/or data characteristic of the security and/or access authorization(s), can be stored and/or are stored. These data are preferably stored according to the individual functional modules (e.g. in the form of a database).

Preferably, no functional module is directly connected (in particular without an intermediate connection via the central module) for communication with an (any) external interface. Preferably, data exchange with a functional module into the external interface must take place via the central module.

The control system between a (preferably every) functional module and the central module preferably has (in each case) at least one and preferably exactly one (in particular protected) communication channel. The control system is preferably configured in such a way that at least one (protected) communication channel can be set up between each functional module and the central module. However, it is also conceivable that a functional module, for example a real-time communication module, does not have a (configured) communication channel to the central module.

Preferably, the control system has at least one central module executed as a security module, at least one real-time application functional module, at least one real-time communication functional module, at least one communication functional module and/or at least one application functional module.

Preferably, each functional module and/or the central module can directly access the operating system or operating system resources.

The control system is preferably equipped with a real-time capable (or deterministically executable) operating system.

In another advantageous embodiment, it can be specified to the control system, or the control system can be configured, in such a way that a functional module performs a function itself that can be delegated to the central module (or is executable by the central module). The use of the security module and/or the central module is preferably optional, i.e. an application running as a (functional) module, can use all, a portion, or even none of the security functions provided or functions otherwise offered by the central module, depending on the application.

In another advantageous embodiment, the control system is suitable for and designed to verify the trustworthiness of a functional module to be installed and/or executed. Preferably, the control system, and in particular the central module, is configured in such a way that only modules (functional modules) can be installed and/or executed if they are or have been installed from trustworthy sources (store principle). The central module (in its capacity as a security module) is preferably responsible for verifying the trustworthiness (of a functional module or application to be installed and/or executed).

Preferably, at least one application is executed in an operating state of the control system and/or of the device or system to be open-loop and/or closed-loop controlled and/or monitored. The control system is preferably characterized by the plurality of isolated execution environments, wherein the hardware of the control system can be either distributed and/or in the form of a physical unit.

The disclosure is additionally directed towards an automation device. According to the disclosure, it has a control system according to an embodiment described above. The automation device is preferably equipped with an external housing within which the hardware and/or the processor and/or the storage device are arranged.

The disclosure is further directed toward an automation system having at least one automation device and preferably having a plurality of automation devices, and particularly preferably having a plurality of field devices. According to the disclosure, the automation system comprises a control system according to an embodiment described above. Preferably, using the automation device and in particular by means of the control system, the monitoring, open-loop and/or closed-loop control of at least one (automated) process executed by the automation system can be carried out (e.g. using a field device).

The disclosure is further directed toward an, in particular, industrial (open-loop and/or closed-loop control and/or monitoring) method in industrial automation technology for operating a control system having hardware comprising at least one processor and at least one storage device, in which applications to be executed by the control system can be stored, comprising at least one and preferably all of the following steps:
providing at least one application and preferably a plurality of applications executed, which in particular can be executed in an isolated execution environment as a functional module; the functional modules can preferably be executed in isolation from each other. The functional modules are preferably capable of running independently.
providing at least one and preferably exactly one central module, which in particular is executable in an isolated execution environment;
adopting at least one security measure for at least one functional module and preferably for a plurality of functional modules by means of the central module. The central module preferably contributes to ensuring the security of at least one functional module and preferably of a plurality of functional modules and particularly preferably, of all functional modules.

Preferably, the central module manages (IT) security-relevant measures at least partially and preferably completely, such as a transport encryption, user and group management and/or enforcement of access restrictions, for the entire control system and/or for at least one functional module and/or for all functional modules.

The method can be equipped with all the above method steps and features described in connection with the control system, either individually or in combination with each other, which must therefore be viewed as being disclosed separately and in combination as well as in connection with the system controller (and also with the automation device). Conversely, the system controller and the automation device are preferably suitable for and designed to execute the method steps described in connection with the system controller, individually or in combination with each other. The control system or automation device is preferably suitable for carrying out at least one (software) task from the field of control engineering, in particular a machine control function.

Preferably, two functional modules can only communicate with each other via defined or specified interfaces and/or communication channels.

Preferably, one (preferably each) of these as a functional module provides (only a few), in particular security-relevant, configuration data to the central module. Security is preferably (subsequently) enforced by the central module during access to the control system or the (automation) device.

Preferably, the central module can be optionally used by the individual functional modules. An application executed as a module can preferably use all, some or none of the security functions provided by the central module, in particular depending on the application. Individual functional modules preferably delegate security-relevant measures to the central module.

The central module is preferably used as a proxy. The central module is preferably suitable for bundling requests to the device as a proxy and/or for granting access to applications only via a defined access route. Preferably, the central module manages access rights.

Preferably, the central module checks the trustworthiness of a functional module to be installed and/or executed and/or of an application to be installed and/or executed.

Preferably, during installation of an application and/or execution of the application as a functional module, an isolated execution environment is set up in which this application is (exclusively) executed (with the exclusive allocation of physical hardware resources). Preferably, a (protected) communication channel is set up between the isolated execution environment or the functional module and the central module.

The disclosure is additionally directed toward a computer program, comprising commands that cause the above-described control system according to an embodiment to execute the method steps of the above described method according to an embodiment.

The disclosure is additionally directed toward a computer-readable storage medium on which the above-described computer program according to an embodiment is stored.

### BRIEF DESCRIPTION OF THE DRAWINGS

Further advantages and embodiments are obtained from the attached drawings.

In the drawings:

FIG. 1 shows a schematic representation of a structure of a monolithic control system according to an embodiment from the prior art; and

FIG. 2 shows a schematic representation of a structure of a control system according to the disclosure according to one embodiment.

### DETAILED DESCRIPTION

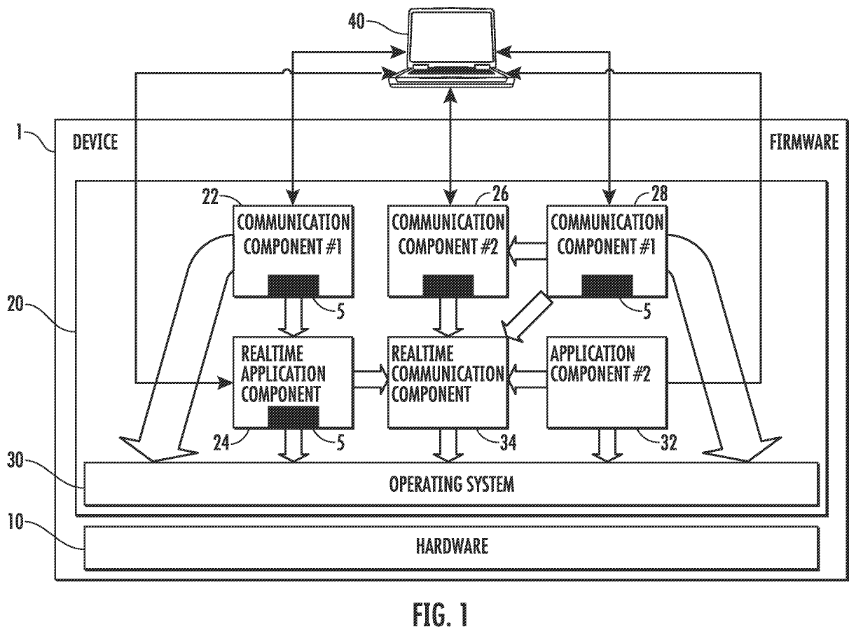

FIG. 1 shows a schematic representation of a structure of a conventional monolithic automation system or control system. Reference sign 1 indicates an automation device. This automation device 1 can comprise (at least partially or completely) a control system, or can also be part of an automation system that has a control system.

Reference sign 10 indicates a (physical) hardware device of the industrial control system. Reference sign 30 indicates the operating system layer, for example, a real-time operating system running on the hardware 10. The hardware has, in particular, (at least) one processor and at least one storage device.

Reference sign 20 indicates the firmware of the control system. During an update, the section (firmware) labeled with reference sign 20 must be completely replaced, even if an error has occurred in only one component, for example Communication Module #1.

FIG. 1 also shows that each application offers services beyond the device boundaries. In FIG. 1, for example, the single-line double arrows illustrate a communication or the data transfer between different components, for example between the individual components 22, 24, 26, 28 and 32 and the external computer 40. Here reference sign 22 indicates a Communication Component #1, reference sign 24 indicates a Real-time Application Component, reference sign 26 indicates a Communication Component #2, reference sign 28 an Application Component #1, and reference sign 32 an Application Component #2. Only the real-time communication component labeled 34 does not have a (direct) communication connection to an external device, the computer 40.

FIG. 1 also illustrates the fact that a plurality of components, namely the components labeled with the reference signs 22, 26, 28 and 24, each have a security device indicated by reference sign 5. This security device 5 ensures an (IT) security of the respective component (for example, the communication connection to an external device).

The (broader) single arrows illustrate the fact that different components, in this case the Real-time Application Component 24, the Real-time Communication Component 33, the Communication Component #1 labeled by reference sign 22, the Communication Component #2 labeled by reference sign 26, the Application Component #1 labeled by reference sign 28 and the Application Component #2 labeled by reference sign 32, each depend on the operating system module 30. In addition, there are dependencies between the different components, which are also illustrated by (broader) single arrows. For example, the Communication Component #1 (reference sign 22) depends on the Real-time Application Component 24, which in turn depends on the Real-time Communication Component 34.

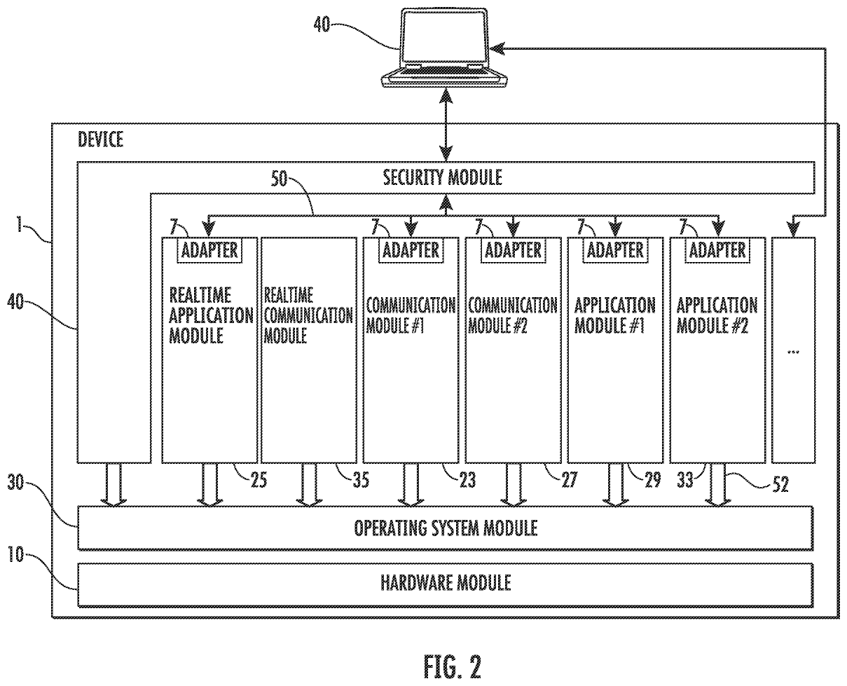

FIG. 2 shows a schematic representation of a structure of a control system according to the disclosure according to one embodiment. In this case an exemplary implementation of a modular (control) system is illustrated. This control system can be arranged in an automation device 1.

The individual functional modules, indicated by the reference signs 25, 35, 23, 27, 29 and 33, which here are the Real-time Application Module 25, the Real-time Communication Module 35, the Communication Module #1 labeled with reference sign 23, the Communication Module #2 labeled with reference sign 27, the Application Module #1 labeled with reference sign 29 and the Application Module #2 labeled with reference sign 33, optionally provide the Security Module 40 (generally referred to above as a central module) with configuration data via an adapter 7. The security module 40 (generally referred to above as a central module) provides security functions in return. In FIG. 2, the single-line double arrows illustrate a communication (connection) and/or a loose coupling between different modules, in particular between the individual functional modules 23, 35, 23, 27, 29 and 33 on the one hand and the central module, here Security Module 40.

The (broader) single arrows, indicated for example by the reference sign 52, illustrate that the central module (in this case the security module 40), and the functional modules, in this case the Real-time Application Module 25, the Real-time Communication Module 35, the Communication Module #1 labeled with reference sign 23, the Communication Module #2 labeled with reference sign 27, the Application Module #1 labeled with reference sign 29 and the Application Module #2 labeled with reference sign 33, although in each case being dependent on the operating system module 30, are not dependent on any other module or any other functional module. In contrast to the monolithic prior-art control system (e.g. FIG. 1), the individual functional modules are (executable) independently of each other and can be run stand-alone.

Access via an external interface, e.g. using a computer 40 via an engineering port, to the applications which use the security module 40 is possible exclusively via one (or more) secured communication channels (labeled by reference sign 50, for instance). If this is not possible, an application can continue to provide (for legacy reasons, for example) a separate communication channel (see the module shown at the right-hand edge of FIG. 2, which shows a direct communication connection to the computer 40 shown by a double arrow).

The applicant reserves the right to claim all features disclosed in the application documents as essential to the disclosure, provided they are novel compared to the prior art, whether individually or in combination. It is also noted that in the individual figures features have also been described, which may be advantageous in isolation. The person skilled in the art will recognize immediately that a particular feature described in a figure may be advantageous even without the incorporation of additional features from the same figure. The person skilled in the art will also recognize that advantages can be obtained by a combination of a plurality of features shown in the drawing.

What is claimed is:

1. A control system in industrial automation technology, comprising:
hardware including at least one processor and at least one storage device in which applications to be executed by the control system are stored;
a plurality of mutually isolated execution environments; and
a plurality independently executable and/or operating functional modules each of which is executed and/or operated in an isolated execution environment of the plurality of mutually isolated execution environments,
wherein the functional modules of the plurality of functional modules are characteristic of functions of the control system.

2. The control system according to claim 1, wherein the functions of the control system include at least one of a controller core, an operating system core, applications, and communication.

3. The control system according to claim 1, further comprising:
at least one specified communications channel through which communication and/or interaction between two functional modules of the plurality of functional modules occurs.

4. The control system according to claim 1, further comprising:
at least one central module configured to execute and/or to perform at least one function relating to a functional module of the plurality of functional modules,
wherein the at least one function executed and/or performed by the at least one central module is delegated to the at least one central module by one of the functional modules of the plurality of functional modules, and
wherein the at least one central module executes and/or performs the at least one function in one of the mutually isolated execution environments of the plurality of mutually isolated execution environments.

5. The control system according to claim 4, wherein:
the at least one central module is configured to ensure security of at least one functional module of the plurality of functional modules and/or the control system, and/or
the at least one central module is suitable and/or configured to execute at least one function relating to transport encryption, administration of users and/or groups, and/or enforcement of access restrictions.

6. The control system according to claim 5, further comprising:
an adapter through which at least one functional module of the plurality of functional modules is configured to provide and/or transfer configuration data to the at least one central module,
wherein the configuration data are preferably characteristic of a security measure.

7. The control system according to claim 6, wherein the at least one central module is configured as a proxy for communication requests, for access requests to the applications, and/or for granting access to the applications.

8. The control system according to claim 4, wherein the control system is configured such that one of the functional modules of the plurality of functional modules performs a function that can be delegated to the at least one central module.

9. The control system according to claim 4, wherein the control system is configured to verify a trustworthiness of one of the functional modules of the plurality of functional modules that is to be installed and/or executed.

10. The control system according to claim 1, wherein the control system is included in an automation device.

11. The control system according to claim 10, wherein the automation device is included in an automation system.

12. A method in industrial automation technology for operating a control system having hardware including at least one processor and at least one storage device, in which applications to be executed by the control system are stored, the method comprising:
executing at least one application of the applications in an isolated execution environment as a functional module;
executing at least one central module in another isolated execution environment; and
implementing at least one security measure for the functional module with the at least one central module.

13. The method according to claim 12, wherein a computer program includes commands which cause the control system to execute the method.

14. The method according to claim 13, wherein the computer program is stored on a machine-readable storage medium.
